(19) United States
(12) Patent Application Publication
(10) Pub. No.: US 2017/0126384 A1
(43) Pub. Date: May 4, 2017

(54) SIMPLIFIED SCHEDULING INFORMATION FOR ACKNOWLEDGEMENT IN A WIRELESS COMMUNICATION SYSTEM

(71) Applicant: NEWRACOM, Inc., Irvine, CA (US)

(72) Inventors: Yujin NOH, Irvine, CA (US); Daewon LEE, Irvine, CA (US); Sungho MOON, Irvine, CA (US); Yongho SEOK, Irvine, CA (US)

(21) Appl. No.: 15/337,753

(22) Filed: Oct. 28, 2016

Related U.S. Application Data
(60) Provisional application No. 62/247,562, filed on Oct. 28, 2015.
(60) Provisional application No. 62/342,786, filed on May 27, 2016.

(51) Int. Cl. H04L 5/00; H04W 72/12; H04L 27/26

(52) U.S. Cl. CPC H04L 5/0055; H04L 27/2607; H04W 72/1268; H04W 84/12

(57) ABSTRACT

A method is implemented by a station (STA) in a wireless network to provide an uplink (UL) Orthogonal Frequency Division Multiple Access (OFDMA) acknowledgement. The method includes receiving a first Physical Layer Protocol Data Unit (PPDU), where a Media Access Control (MAC) header of a MAC Protocol Data Unit (MPDU) in the first PPDU includes a Simplified Scheduling Information subfield that carries scheduling information for scheduling the UL OFDMA acknowledgement. The method further includes generating a second PPDU that includes an acknowledgement frame, determining an uplink cyclic prefix length to apply to the second PPDU based on a cyclic prefix length of the first PPDU, where the uplink cyclic prefix length is longer than the cyclic prefix length of the first PPDU, and transmitting the second PPDU through a wireless medium according to the scheduling information, where the uplink cyclic prefix length is applied to the second PPDU.

### CROSS-REFERENCE TO RELATED APPLICATIONS

This application claims the benefit of U.S. Provisional Application No. 62/247,562, filed Oct. 28, 2015 and U.S. Provisional Application No. 62/342,786, filed May 27, 2016, which are hereby incorporated by reference.

### FIELD OF INVENTION

The embodiments described herein related to the field of Wireless Local Area Network (WLAN) operation. More specifically, the embodiments described herein relate to a technique for providing uplink (UL) Orthogonal Frequency Division Multiple Access (OFDMA) acknowledgement in a Wireless Local Area Network (WLAN). Other embodiments are also disclosed.

### BACKGROUND

Institute of Electrical and Electronics Engineers (IEEE) 802.11 is a set of physical and Media Access Control (MAC) specifications for implementing Wireless Local Area Network (WLAN) communications. These specifications provide the basis for wireless network products using the Wi-Fi brand managed and defined by the Wi-Fi Alliance. The specifications define the use of the 2.400-2.500 GHz as well as the 4.915-5.825 GHz bands. These spectrum bands are commonly referred to as the 2.4 GHz and 5 GHz bands. Each spectrum is subdivided into channels with a center frequency and bandwidth. The 2.4 GHz band is divided into 14 channels spaced 5 MHz apart, though some countries regulate the availability of these channels. The 5 GHz band is more heavily regulated than the 2.4 GHz band and the spacing of channels varies across the spectrum with a minimum of a 5 MHz spacing dependent on the regulations of the respective country or territory.

WLAN devices are currently being deployed in diverse environments. These environments are characterized by the existence of many Access Points (APs) and non-AP stations (STAs) in geographically limited areas. Increased interference from neighboring devices gives rise to performance degradation. Additionally, WLAN devices are increasingly required to support a variety of applications such as video, cloud access, and offloading. Video traffic, in particular, is expected to be the dominant type of traffic in WLAN deployments. With the real-time requirements of some of these applications, WLAN users demand improved performance.

In a task group called IEEE 802.11ax, High Efficiency WLAN (HE) standardization is under discussion. The HE aims at improving performance felt by users demanding high-capacity and high-rate services. The HE may support uplink (UL) and downlink (DL) multi-user (MU) simultaneous transmissions, which includes Multi-User Multiple-Input Multiple-Output (MU-MIMO) and Orthogonal Frequency Division Multiple Access (OFDMA) transmissions.

An AP may initiate a UL MU simultaneous transmission by transmitting a trigger frame to the STAs that are to participate in the UL MU simultaneous transmission. The trigger frame may include scheduling information for the UL MU simultaneous transmission such as information regarding the intended participants of the UL MU simultaneous transmission and information regarding the assignment of transmission resources to those intended participants.

The HE may allow DL MU simultaneous transmissions and UL MU simultaneous transmissions within a transmission opportunity (TXOP) in a cascaded manner. For example, a TXOP may include a DL MU simultaneous transmission immediately followed by a UL MU simultaneous transmission. The AP may desire that the STAs provide immediate acknowledgement for the downlink frames they successfully receive from the DL MU simultaneous transmission. Overhead for the acknowledgement can be reduced by allowing the STAs to simultaneously transmit their respective acknowledgement frames to the AP in OFDMA manner (which is referred to as a UL OFDMA acknowledgement) as part of the UL MU simultaneous transmission that immediately follows the DL MU simultaneous transmission.

Scheduling information for scheduling the UL OFDMA Acknowledgement may be carried in the MAC header of a downlink frame. For example, the scheduling information may be carried in the High Throughput (HT) Control field (e.g., HE variant HT Control field) of the MAC header. However, the HT Control field has limited size (e.g., 4 bytes), and thus it may not be possible for the HT Control field to carry the full range of scheduling information that is typically included in standard trigger frames.

### SUMMARY

A method is implemented by a station (STA) in a Wireless Local Area Network (WLAN) to provide an uplink (UL) Orthogonal Frequency Division Multiple Access (OFDMA) acknowledgement. The method includes receiving a first Physical Layer Protocol Data Unit (PPDU), where the first PPDU includes a Media Access Control (MAC) Protocol Data Unit (MPDU), where a MAC header of the MPDU includes a High Efficiency (HE) variant High Throughput (HT) Control field, where the HE variant HT Control field includes a Simplified Scheduling Information subfield that carries scheduling information for scheduling the UL OFDMA acknowledgement. The method further includes generating a second PPDU in response to receiving the first PPDU, where the second PPDU includes an acknowledgement frame, determining a cyclic prefix length of the first PPDU, determining an uplink cyclic prefix length to apply to the second PPDU based on the cyclic prefix length of the first PPDU, where the uplink cyclic prefix length is longer than the cyclic prefix length of the first PPDU when the cyclic prefix length of the first PPDU is shorter than a maximum allowed cyclic prefix length, and transmitting the second PPDU through a wireless medium according to the scheduling information, where the uplink cyclic prefix length is applied to the second PPDU.

A network device configured to function as a station (STA) in a Wireless Local Area Network (WLAN) to participate in an uplink (UL) multi-user (MU) response transmission. The network device includes a Radio Frequency (RF) transceiver, a set of one or more processors, and a non-transitory machine-readable storage medium having stored therein an uplink (UL) multi-user (MU) response transmission component. The UL MU response transmission component, when executed by the set of one or more processors, causes the network device to receive a first Physical Layer Protocol Data Unit (PPDU), where the first PPDU includes a Media Access Control (MAC) Protocol Data Unit (MPDU), where a MAC header of the MPDU includes a High Efficiency (HE) variant High Throughput (HT) Control field, where the HE variant HT Control field includes a Simplified Scheduling Information subfield that carries scheduling information for scheduling the UL MU response transmission, generate a second PPDU in response to receiving the first PPDU, determine a cyclic prefix length of the first PPDU, determine an uplink cyclic prefix length to apply to the second PPDU based on the cyclic prefix length of the first PPDU, where the uplink cyclic prefix length is longer than the cyclic prefix length of the first PPDU when the cyclic prefix length of the first PPDU is shorter than a maximum allowed cyclic prefix length, and transmit the second PPDU through a wireless medium according to the scheduling information, where the uplink cyclic prefix length is applied to the second PPDU.

A non-transitory machine-readable medium has computer code stored therein, which when executed by a set of one or more processors of a network device functioning as a station (STA) in a Wireless Local Area Network (WLAN), causes the first network device to perform operations for providing an uplink (UL) Orthogonal Frequency Division Multiple Access (OFDMA) acknowledgement. The operations include receiving a first Physical Layer Protocol Data Unit (PPDU), where the first PPDU includes a Media Access Control (MAC) Protocol Data Unit (MPDU), where a MAC header of the MPDU includes a High Efficiency (HE) variant High Throughput (HT) Control field, where the HE variant HT Control field includes a Simplified Scheduling Information subfield that carries scheduling information for scheduling the UL OFDMA acknowledgement. The operations further include generating a second PPDU in response to receiving the first PPDU, where the second PPDU includes an acknowledgement frame, determining a cyclic prefix length of the first PPDU, determining an uplink cyclic prefix length to apply to the second PPDU based on the cyclic prefix length of the first PPDU, where the uplink cyclic prefix length is longer than the cyclic prefix length of the first PPDU when the cyclic prefix length of the first PPDU is shorter than a maximum allowed cyclic prefix length, and transmitting the second PPDU through a wireless medium according to the scheduling information, where the uplink cyclic prefix length is applied to the second PPDU.

### BRIEF DESCRIPTION OF THE DRAWINGS

Embodiments are illustrated by way of example, and not by way of limitation, in the figures of the accompanying drawings in which like references indicate similar elements. It should be noted that different references to “an” or “one” embodiment in this specification are not necessarily to the same embodiment, and such references mean at least one. Further, when a particular feature, structure, or characteristic is described in connection with an embodiment, it is submitted that it is within the knowledge of one skilled in the art to affect such feature, structure, or characteristic in connection with other embodiments whether or not explicitly described.

FIG. 1 is a diagram illustrating cascaded DL MU simultaneous transmissions and UL MU simultaneous transmissions within a TXOP, according to some embodiments.

FIG. 2 is a diagram illustrating a UL OFDMA acknowledgement, according to some embodiments.

FIG. 3 is a diagram illustrating a field format for a MAC frame that includes an HE variant HT Control field, according to some embodiments.

FIG. 4A is a diagram illustrating a field format for a MAC frame that carries simplified scheduling information, according to some embodiments.

FIG. 4B is a diagram illustrating another field format for a MAC frame that carries simplified scheduling information, according to some embodiments.

FIG. 5 is a flow diagram of a process for providing a UL OFDMA acknowledgement, according to some embodiments.

FIG. 6 is a block diagram of a network device implementing a STA or AP that executes a UL OFDMA acknowledgement component, according to some embodiments.

FIG. 7 is a block diagram of a WLAN, according to some embodiments.

FIG. 8 is a schematic block diagram exemplifying a transmitting signal processor in a WLAN device, according to some embodiments.

FIG. 9 is a schematic block diagram exemplifying a receiving signal processing unit in a WLAN device, according to some embodiments.

FIG. 10 is a timing diagram providing an example of the Carrier Sense Multiple Access/Collision Avoidance (CSMA/CA) transmission procedure, according to some embodiments.

### DETAILED DESCRIPTION

The embodiments disclosed herein provide methods and apparatus for providing an uplink (UL) Orthogonal Frequency Division Multiple Access (OFDMA) acknowledgement. An embodiment is a method implemented by a station (STA) in a Wireless Local Area Network (WLAN). The method includes receiving a first Physical Layer Protocol Data Unit (PPDU), where the first PPDU includes a Media Access Control (MAC) Protocol Data Unit (MPDU), where a MAC header of the MPDU includes a High Efficiency (or High Efficiency WLAN) (HE) variant High Throughput (HT) Control field, where the HE variant HT Control field includes a Simplified Scheduling Information subfield that carries scheduling information for scheduling the UL OFDMA acknowledgement. The method further includes generating a second PPDU in response to receiving the first PPDU, where the second PPDU includes an acknowledgement frame, determining a cyclic prefix length of the first PPDU, determining an uplink cyclic prefix length to apply to the second PPDU based on the cyclic prefix length of the first PPDU, where the uplink cyclic prefix length is longer than the cyclic prefix length of the first PPDU when the cyclic prefix length of the first PPDU is shorter than a maximum allowed cyclic prefix length, and transmitting the second PPDU through a wireless medium according to the scheduling information, where the uplink cyclic prefix length is applied to the second PPDU. Other embodiments are also described and claimed.

In the following description, numerous specific details are set forth. However, it is understood that embodiments described herein may be practiced without these specific details. In other instances, well-known circuits, structures and techniques have not been shown in detail in order not to obscure the understanding of this description. It will be appreciated, however, by one skilled in the art that the embodiments described herein may be practiced without such specific details. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other. A “set,” as used herein refers to any positive whole number of items including one item.

An electronic device stores and transmits (internally and/or with other electronic devices over a network) code (which is composed of software instructions and which is sometimes referred to as computer program code or a computer program) and/or data using machine-readable media (also called computer-readable media), such as non-transitory machine-readable media (e.g., machine-readable storage media such as magnetic disks, optical disks, read only memory, flash memory devices, phase change memory) and transitory machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors coupled to one or more non-transitory machine-readable storage media (to store code for execution on the set of processors and data) and a set of one or more physical network interface(s) to establish network connections (to transmit code and/or data using propagating signals). Put another way, a typical electronic device includes memory comprising non-volatile memory (containing code regardless of whether the electronic device is on or off) and volatile memory (e.g., dynamic random access memory (DRAM), static random access memory (SRAM)), and while the electronic device is turned on that part of the code that is currently being executed is copied from the slower non-volatile memory into the volatile memory (often organized in a hierarchy) for execution by the processors of the electronic device.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video). Network devices or network elements can include Access Points (APs) and non-AP stations (STAs) in wireless communications systems such as a WLAN. STAs are devices connected to and communicating in a WLAN including client or user devices that connect to the WLAN via APs. APs are network devices that may be specialized wireless access points that can communicate with other network devices in the WLAN via the wireless medium or via wired connections. APs may be considered to be a type of STA. A non-AP STA or AP may be referred to herein as a WLAN device or STA.

As mentioned above, in a task group called Institute of Electrical and Electronics Engineers (IEEE) 802.11ax, HE WLAN (HE) standardization is under discussion. The HE may support uplink (UL) and downlink (DL) multi-user (MU) simultaneous transmissions. In an MU simultaneous transmission, multiple frames are transmitted to or from multiple STAs simultaneously using different resources, where the different resources could be different frequency resources in the case of an OFDMA transmission or different spatial streams in the case of a Multi-User Multiple-Input Multiple Output (MU-MIMO) transmission. Examples of MU simultaneous transmission include DL OFDMA, DL MU-MIMO, UL OFDMA, and UL MU-MIMO.

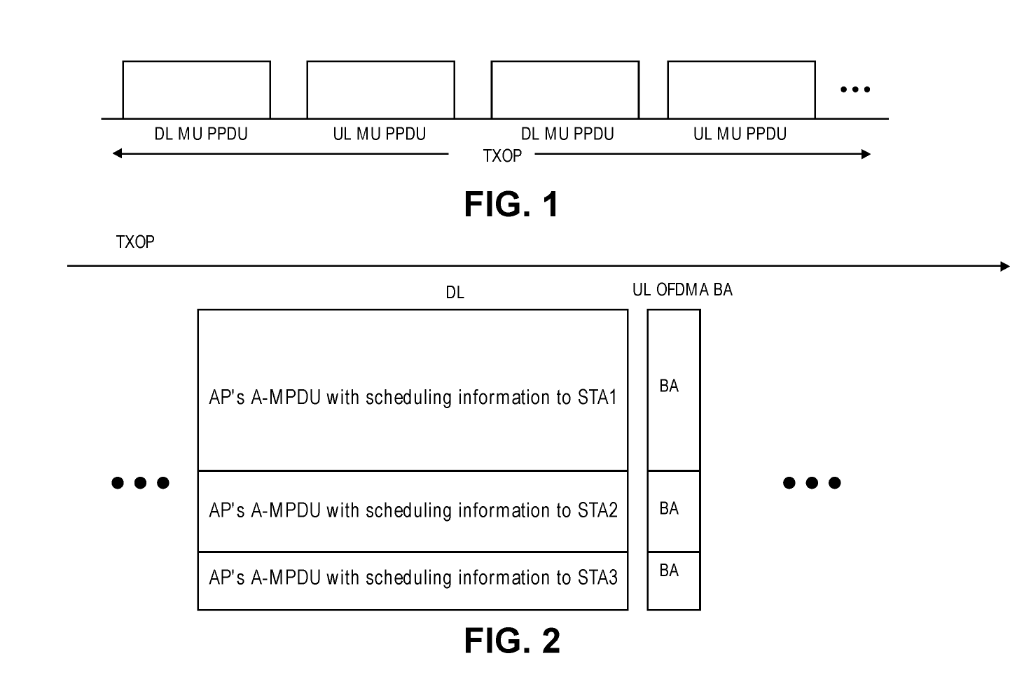

The HE may allow DL MU simultaneous transmissions and UL MU simultaneous transmissions within a transmission opportunity (TXOP) in a cascaded manner. For example, as shown in FIG. 1, a TXOP may include a DL MU simultaneous transmission (DL MU PPDU transmitted by AP to STAs) immediately followed by a UL MU simultaneous transmission (UL MU PPDU transmitted by STAs to AP), which is followed by another DL MU simultaneous transmission followed by another UL MU simultaneous transmission, and so on.

The AP may desire that the STAs provide immediate acknowledgement for the downlink frames they successfully receive from a DL MU simultaneous transmission. Overhead for the acknowledgement can be reduced by allowing the STAs to simultaneously transmit their respective acknowledgement frames to the AP in OFDMA manner as part of the UL MU simultaneous transmission that immediately follows the DL MU simultaneous transmission. The transmission of acknowledgement frames in OFDMA manner may be referred to herein as a UL OFDMA acknowledgement. For example, as shown in FIG. 2, an AP may transmit a DL MU PPDU to three STAs (STA1, STA2, and STA3). The DL MU PPDU includes an Aggregated Media Access Control Protocol Data Unit (A-MPDU) intended for STA1 (in a first transmission resource), an A-MPDU intended for STA2 (in a second transmission resource), and an A-MPDU intended for STA3 (in a third transmission resource). Each A-MPDU may carry information for scheduling an immediately following UL OFDMA acknowledgement. For example, the A-MPDU intended for STA1 may include scheduling information pertaining to STA1, the A-MPDU intended for STA2 may include scheduling information pertaining to STA2, and the A-MPDU intended for STA3 may include scheduling information pertaining to STA3. The presence of this scheduling information serves to solicit an immediate UL OFDMA acknowledgement from the STAs. In response to receiving the DL MU PPDU, STA1, STA2, and STA3 may simultaneously transmit their respective acknowledgement frames (e.g., Acknowledgement (ACK) frame or Block Acknowledgement (BA) frame) to the AP in OFDMA manner according to the scheduling information to provide a UL OFDMA acknowledgement.

As will be described in additional detail below, in one embodiment, the scheduling information for the UL OFDMA acknowledgement may be carried in the Media Access Control (MAC) header of a downlink frame, and more specifically in the HT Control field of the MAC header of the downlink frame (as opposed to being carried in a standard trigger frame). The HT Control field of the MAC header may be limited in size (e.g., 4 bytes) and thus may not be able to carry the full range of scheduling information that is typically included in standard trigger frames. The scheduling information that is carried in the MAC header may thus be referred to herein as simplified scheduling information. The simplified scheduling information may also be referred to as UL MU response scheduling information.

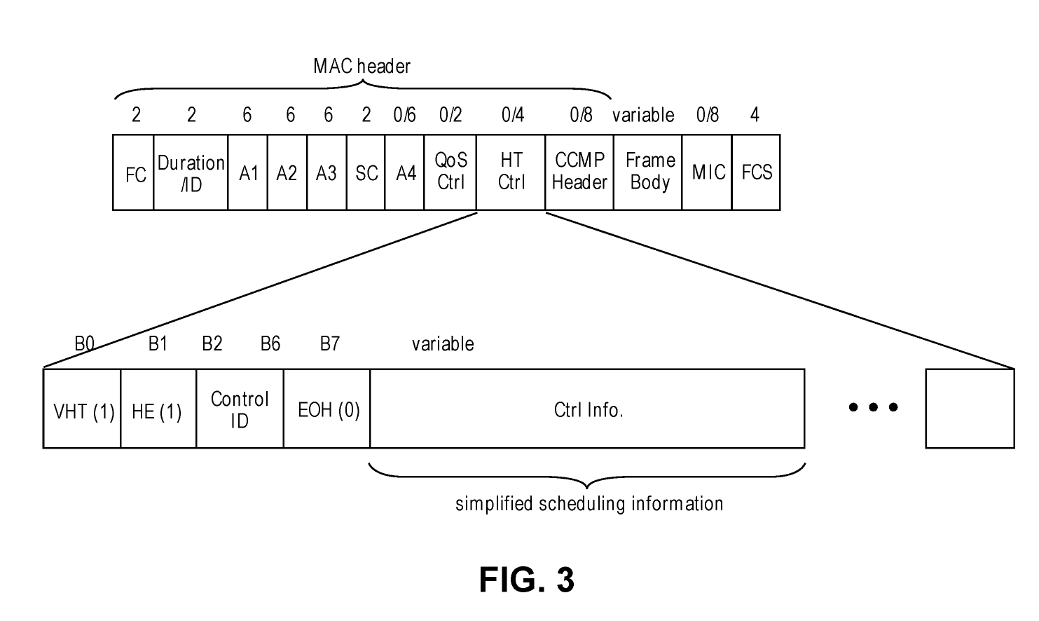

FIG. 3 is a diagram illustrating a field format for a MAC frame that includes an HE variant HT Control field, according to some embodiments. The MAC frame includes, among other fields, an HT Control field in the MAC header. The HT control field may be used to carry various control information. The HT Control field may have a different field format depending on the variant. The possible variants may include the HT variant (e.g., for IEEE 802.11n), the VHT variant (for IEEE 802.11ac), and the HE variant (e.g., for IEEE 802.11ax). In this example, the HT Control field is an HE variant HT Control field. In one embodiment, the first two bits of the HT Control field are both set to a value of ‘1’ to indicate that the HT Control field is an HE variant HT Control field. The HE variant HT Control field may include one or more HE Control subfields, where each HE Control subfield is used to carry a particular type of control information. Each HE Control subfield field may include a Control Identifier (ID) subfield, an End of HE Control (EOH) subfield, and a Control Information subfield. The Control ID subfield of an HE Control subfield field may be used to carry information regarding the type of control information carried in the Control Information subfield of that HE Control subfield. The EOH subfield may be used to indicate whether another HE Control subfield follows the current HE Control subfield. The Control Information subfield may be used to carry the actual control information.

In one embodiment, an HE Control subfield may be used to carry simplified scheduling information (e.g., UL MU response scheduling information). In one embodiment, the Control ID subfield of the HE Control subfield is set to a value of ‘0’ to indicate that the HE Control subfield carries simplified scheduling information. The simplified scheduling information includes information for scheduling a UL OFDMA acknowledgement. The simplified scheduling information is “simplified” or “compressed” in the sense that it may not include the full range of scheduling information that is typically included in standard trigger frames due to the limited space available in the HE variant HT Control field. A Control Information subfield (e.g., in an HE Control subfield) that is used to carry simplified scheduling information may be referred to herein as a Simplified Scheduling Information subfield (or UL MU Response Scheduling subfield). In one embodiment, the Simplified Scheduling Information subfield includes one or more of the following subfields (e.g., in the Control Information subfield of the Simplified Scheduling Information subfield) to carry simplified scheduling information. It should be understood that the following subfields are provided by way of example and not limitation. It should be understood that the Simplified Scheduling Information subfield can include other subfields to carry other types of scheduling information.

1) Cyclic Prefix (CP)/Guard Interval (GI) subfield. The CP/GI subfield may be used to carry information regarding the CP/GI length/duration to use for the UL OFDMA acknowledgement. Given delay spread in a channel, Intersymbol Interference (ISI) between Orthogonal Frequency-Division Multiplexing (OFDM) symbols and adjacent OFDM symbols in time degrades the orthogonality between subcarriers, which can negatively affect system performance. In order to minimize or reduce performance loss, CP/GI is added in between adjacent OFDM symbols. In order to prevent significant interference among STAs in a UL MU simultaneous transmission (e.g., UL OFDMA acknowledgement), the frames transmitted by STAs need to be time-aligned at the AP within a given CP/GI length/duration. Since UL MU simultaneous transmissions are formed by multiple STAs, a longer CP/GI length/duration may be needed for UL MU simultaneous transmissions as opposed to DL MU simultaneous transmissions in order to cover the delay difference and inaccurate timing among multiple STAs. As such, using the same CP/GI length/duration as the DL MU simultaneous transmission for the UL OFDMA acknowledgement may result in ISI and may negatively impact the performance of the UL OFDMA acknowledgement.

In one embodiment, when there is not enough space for the CP/GI subfield in the Simplified Scheduling Information subfield (and thus no CP/GI information is provided), CP/GI length/duration of the UL OFDMA acknowledgement may be implicitly determined based on CP/GI length/duration of the downlink PPDU that solicits the UL OFDMA acknowledgment and the longest allowed CP/GI length/duration in the system. In an aspect, the STA may use the longest allowed CP/GI length/duration or the next longest allowed CP/GI length/duration compared to the CP/GI length/duration of the downlink PPDU. For example, in a system where the allowed CP/GI length/duration values are 0.8 microseconds, 1.6 microseconds, and 3.2 microseconds, the STA may always use the longest of the allowed CP/GI length/duration values (3.2 microseconds) when transmitting an acknowledgment frame as part of a UL OFDMA acknowledgment in response to receiving a downlink frame carrying simplified scheduling information. As another example, if the downlink PPDU that solicits UL OFDMA acknowledgment uses a CP/GI length/duration of 0.8 microseconds, then the STA may use the next longest allowed CP/GI length/duration value (1.6 microseconds) when transmitting an acknowledgement frame as part of the UL OFDMA acknowledgement. In a similar manner, if the downlink PPDU that solicits UL OFDMA acknowledgement uses a CP/GI length/duration of 1.6 microseconds, then the STA may use a CP/GI length/duration of 3.2 microseconds when transmitting an acknowledgement frame as part of the UL OFDMA acknowledgement.

2) PPDU Length subfield. The PPDU length subfield may be used to carry information regarding the length/duration of the UL OFDMA acknowledgement.

3) Resource Unit (RU) Indication subfield. The RU Indication subfield may be used to carry information regarding the transmission resource (e.g., a subchannel) that a STA is to use for the UL OFDMA acknowledgement. In one embodiment, if the indication of the transmission resource is limited to a certain bandwidth, the Simplified Scheduling Information subfield may include a Bandwidth (BW) subfield that is used to carry information regarding the bandwidth.

4) Modulation Coding Scheme (MCS) subfield. The MCS subfield may be used to carry information regarding the MCS that a STA is to use for the UL OFDMA acknowledgement. Generally, the MCS used for acknowledgements is the lowest allowed MCS in order to allow the acknowledgements to be decoded and demodulated correctly. In one embodiment, different STAs among the STAs that participate in the UL OFDMA acknowledgement may be assigned a different MCS depending on each STA's unique circumstances. In another embodiment, the STAs that participate in the UL OFDMA acknowledgement are all assigned the same MCS (e.g., the lowest allowed MCS). In one embodiment, the DCM subfield may be used to carry information regarding the use of Dual Sub-Carrier Modulation (DCM). With DCM, the same information may be paired in subcarrier n and subcarrier m, where subcarrier n and subcarrier m are separated within an assigned transmission resource. DCM may help increase robustness and handle smaller subband interference.

In one embodiment, when there is not enough space for the MCS subfield in the Simplified Scheduling Information subfield (and thus no MCS information is indicated), the STA may use the lowest available MCS (or MCS with lowest data rate) for the UL OFDMA acknowledgment. Information regarding the use of DCM may still be included as part of the simplified scheduling information since the same MCS could use different DCM.

5) Number of Space-time Streams (Nsts) subfield. The Number of Space-time Streams subfield may be used to carry information regarding the number of space-time streams that a STA is to use for the UL OFDMA acknowledgement. Since the AP and the STA may use different number of space-time streams, the same number of space-time streams that is used for the downlink PPDU may not be applicable for the UL OFDMA acknowledgement. In one embodiment, the number of Long Training Fields (LTFs) is equal to the number of space-time streams except that for 3, 5, and 7 space-time streams, 4, 6, and 8 training symbols are needed, respectively.

6) LTF Type subfield. The LTF Type subfield may be used to carry information regarding the LTF type of the UL OFDMA acknowledgment. An example of an LTF type is 2×HE LTF. 2×HE LTF modulates every other tone in an OFDM symbol of 12.8 microseconds (duration of 4×HE LTF excluding GI) and then removes the second half of the OFDM symbol in the time domain. Depending on the UL and DL channel conditions, 2×HE LTF may improve channel estimation performance.

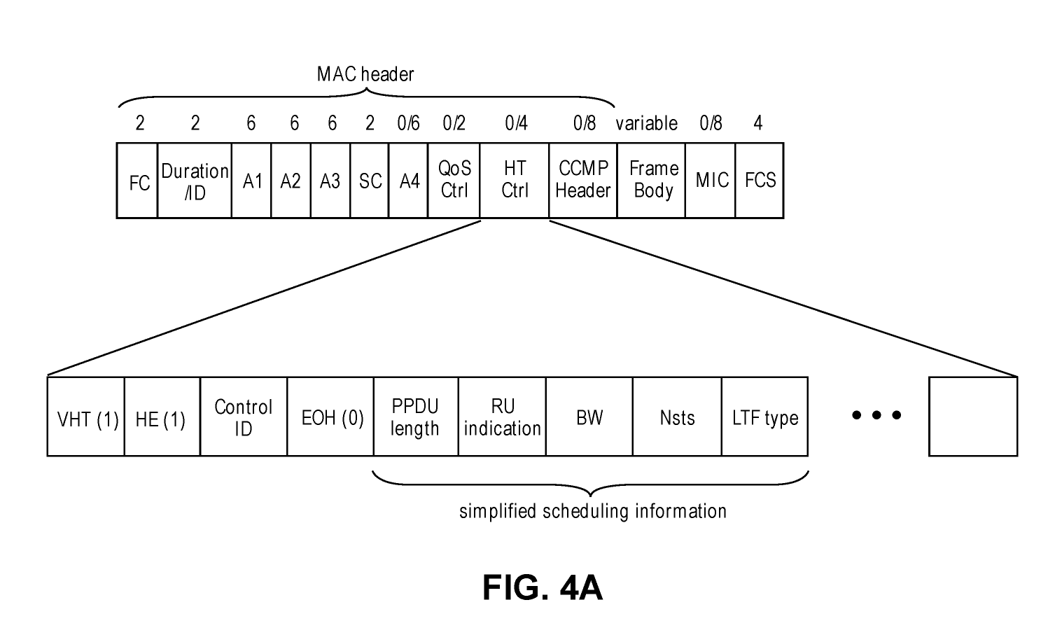

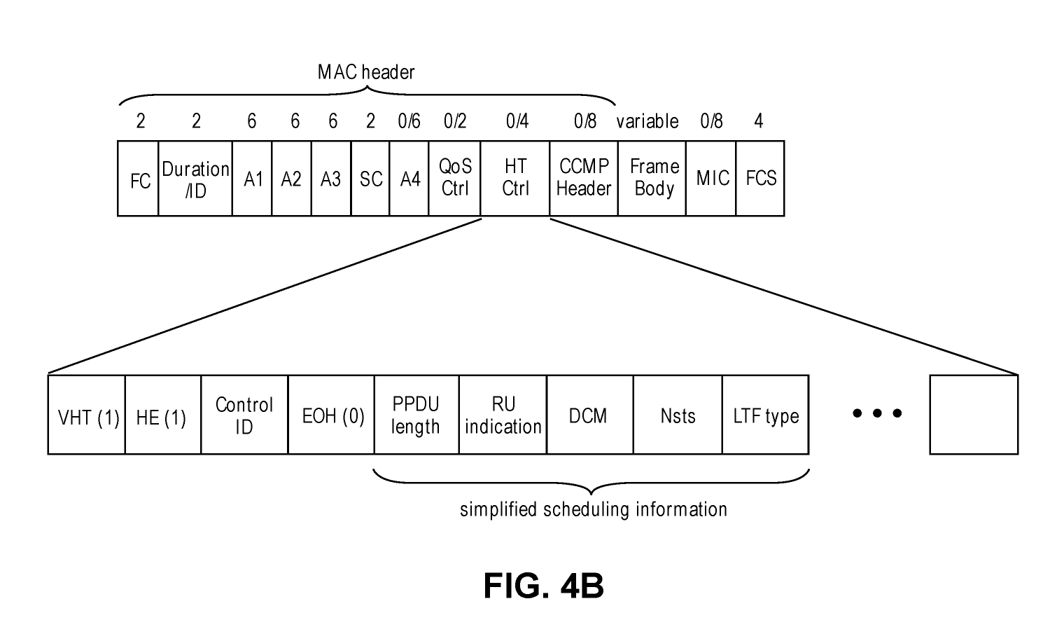

Considering that the HE variant HT Control field is limited in size, the Simplified Scheduling Information subfield may not have enough space to carry the full range of scheduling information that is typically included in standard trigger frames. As such, the Simplified Scheduling Information subfield carries simplified scheduling information instead of the full scheduling information that is typically included in standard trigger frames. In one embodiment, as shown in FIG. 4A, the Simplified Scheduling Information subfield includes a PPDU Length subfield, an RU Indication subfield, a Bandwidth subfield (that is used to carry information regarding bandwidth), a Number of Space-time Streams subfield, and an LTF type subfield to carry scheduling information, where the RU Indication subfield is used to indicate a particular transmission resource within a 20 MHz bandwidth. In another embodiment, as shown in FIG. 4B, the Simplified Scheduling Information subfield includes a PPDU Length subfield, an RU Indication subfield (regardless of operating channel bandwidth), a DCM subfield, a Number of Space-time Streams subfield, and an LTF type subfield to carry scheduling information, where the RU Indication subfield is used to indicate a transmission resource without regard to the operating channel bandwidth. If there is any additional space remaining in the Simplified Scheduling Information subfield, this space may be reserved for future use.

Since the simplified scheduling information only includes a limited amount of scheduling information, the STA that receives a frame with simplified scheduling information (e.g., in the Simplified Scheduling Information Subfield) may need to implicitly derive scheduling information that is not explicitly provided. For example, in the MAC frames described with reference to FIG. 4A and FIG. 4B, the CP/GI subfield is not included in the Simplified Scheduling Information subfield. As such, the STA that receives such a downlink frame is not explicitly provided with the CP length or GI duration to use for the UL OFDMA acknowledgement. In one embodiment, the STA determines or derives the CP length or GI duration to use for the UL OFDMA acknowledgement based on the CP length or GI duration of the downlink PPDU that solicited the UL OFDMA acknowledgment. For example, the STA may determine the CP length or GI duration to use for the UL OFDMA Acknowledgement based on the following mapping table:

TABLE I

| DL | UL |
|---|---|
| 0.8 μs | 1.6 μs |
| 1.6 μs | 3.2 μs |
| 3.2 μs | 3.2 μs |

According to Table I, if the downlink PPDU uses a CP length or GI duration of 0.8 microseconds, then the STA uses a CP length or GI duration of 1.6 microseconds for the UL OFDMA acknowledgement. If the DL MU PPDU uses a CP length or GI duration of 1.6 microseconds or 3.2 microseconds, then the STA uses a CP length or GI duration of 3.2 microseconds for the UL OFDMA acknowledgement.

In one embodiment, a STA transmitting a UL MU PPDU (e.g., as part of a UL OFDMA acknowledgement) in response to receiving a downlink frame including a Simplified Scheduling Information subfield (e.g., UL MU Response Scheduling subfield) in the HE variant HT Control field sets TXVECTOR for the UL MU PPDU as follows:

N_{SYM} parameter is set to F_{VAL}+1, where F_{VAL} is the value indicated in the PPDU Length subfield of the Simplified Scheduling Information subfield.

UL_TARGET_RSSI, DL_TX_POWER, RU_ALLOCATION, and MCS parameters are set to the values indicated in the UL Target Received Signal Strength Indicator (RSSI) subfield (used to carry information regarding the target receive power), DL TX Power subfield (used to carry information regarding the downlink transmit power), RU Indication subfield, and MCS subfield of the Simplified Scheduling Information subfield, respectively.

BW parameter is set to be equal to the bandwidth of the soliciting DL MU PPDU (the DL MU PPDU that includes the frame including the Simplified Scheduling Information subfield).

BSS_COLOR and DCM parameters are set to the values of the BSS_COLOR and DCM parameters of the RXVECTOR of the soliciting DL MU PPDU, respectively.

MU_MIMO_LTF_MODE, LDPC_EXTRA, NSTS, STBC, CODING TYPE, and SS_ALLOCATION parameters are all set to 0.

SPATIAL_REUSE parameter is set to indicate that spatial reuse is not allowed (e.g., SR_Disallowed).

PACKET_EXTENSION parameter is set to the default packet extension value for UL MU response scheduling indicated by the AP in the HE Operation element it transmits.

TXOP_DURATION parameter is set according the rules for updating two NAVs.

CP_LTF_TYPE parameter is set to the values in Table II below depending on the value of the CP_LTF_TYPE parameter of the soliciting DL MU PPDU:

TABLE II

| CP_LTF_TYPE | CP_LTF_TYPE |
|---|---|
| parameter of the | parameter of the |
| soliciting DL MU PPDU | UL MU PPDU |
| 1x + 0.8 μs | 1x + 1.6 μs |
| 2x + 0.8 μs | 2x + 1.6 μs |
| 2x + 1.6 μs | 2x + 3.2 μs |
| 4x + 3.2 μs | 4x + 3.2 μs |

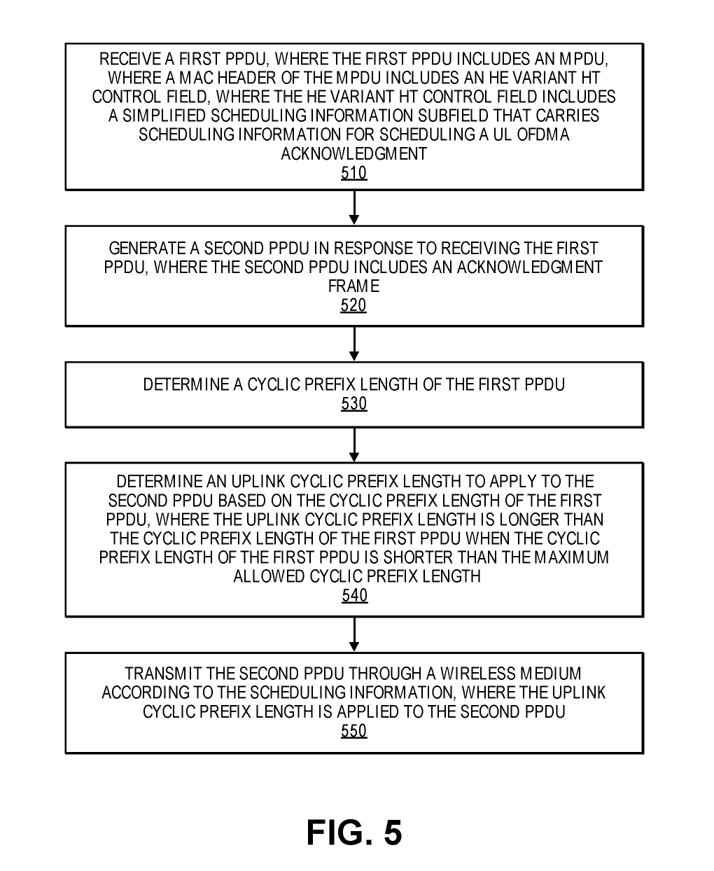

FIG. 5 is a flow diagram of a process for providing a UL OFDMA acknowledgement, according to some embodiments. In one embodiment, the process is implemented by a STA in a WLAN. The operations in this flow diagram will be described with reference to the exemplary embodiments of the other figures. However, it should be understood that the operations of the flow diagram can be performed by embodiments other than those discussed with reference to the other figures, and the embodiments discussed with reference to these other figures can perform operations different than those discussed with reference to the flow diagram.

In one embodiment, the process is initiated when the STA receives a first PPDU, where the first PPDU includes an MPDU, where a MAC header of the MPDU includes an HE variant HT Control field, where the HE variant HT Control field includes a Simplified Scheduling Information subfield that carries scheduling information for scheduling a UL OFDMA acknowledgement (block 510). The presence of the Simplified Scheduling Information subfield (and the scheduling information provided therein) serves to solicit a UL OFDMA acknowledgement from the STA. In one embodiment, the Simplified Scheduling Information subfield may include one or more of a PPDU length subfield, an RU Indication subfield, an MCS subfield, a Number of Space-time Streams subfield, and an LTF type subfield, but not a CP/GI subfield.

The STA generates a second PPDU in response to receiving the first PPDU, where the second PPDU includes an acknowledgement frame (block 520). The acknowledgement frame may serve to acknowledge one or more frames that were received from a transmitting STA (e.g., an AP) in the first PPDU. In one embodiment, the acknowledgement frame is a standard Acknowledgement (ACK) frame. In another embodiment, the acknowledgement frame is a Block ACK (BA) frame.

The STA determines a cyclic prefix length of the first PPDU (block 530). In one embodiment, the cyclic prefix length of the first PPDU is determined from the CP_LTF_TYPE parameter of the RXVECTOR of the first PPDU.

The STA determines an uplink cyclic prefix length to apply to the second PPDU based on the cyclic prefix length of the first PPDU, where the uplink cyclic prefix length is longer than the cyclic prefix length of the first PPDU when the cyclic prefix length of the first PPDU is shorter than the maximum allowed cyclic prefix length (block 540). In one embodiment, the uplink cyclic prefix length is the same as the maximum allowed cyclic prefix length when the cyclic length of the first PPDU is the same as the maximum allowed cyclic prefix length. In one embodiment, the allowed cyclic prefix lengths are 0.8 microseconds, 1.6 microseconds, and 3.2 microseconds, where 3.2 microseconds is the maximum allowed cyclic prefix length. In one embodiment, the uplink cyclic prefix length can be determined according to the mapping described with reference to Table I.

The STA then transmits the second PPDU (e.g., to the STA that transmitted the first PPDU, which may be an AP) through a wireless medium according to the scheduling information, where the uplink cyclic prefix length is applied to the second PPDU (block 550). In this way, the STA may transmit the second PPDU in an OFDMA manner together with other STAs (essentially simultaneously) to provide a UL OFDMA acknowledgement.

Although embodiments have been primarily described in a context where the simplified scheduling information carried in the MAC header serves to solicit a UL OFDMA acknowledgement, it should be understood that the simplified scheduling information carried in the MAC header can also serve to solicit a UL MU simultaneous transmission (e.g., UL MU response transmission) for purposes other than acknowledgement.

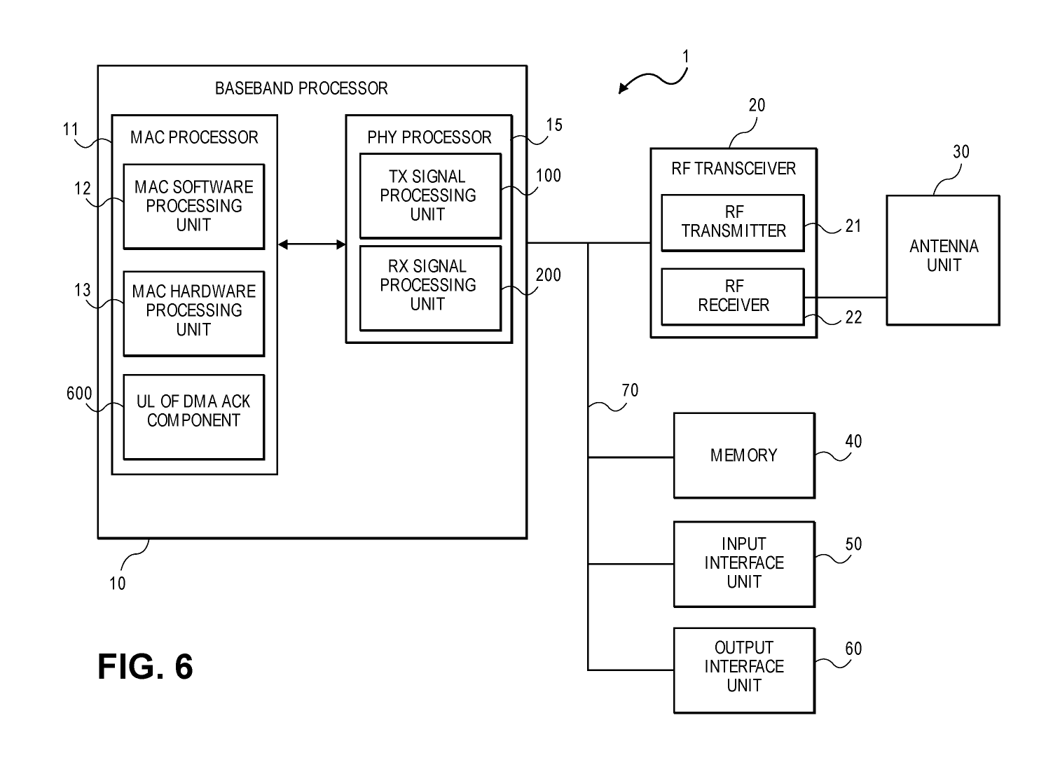

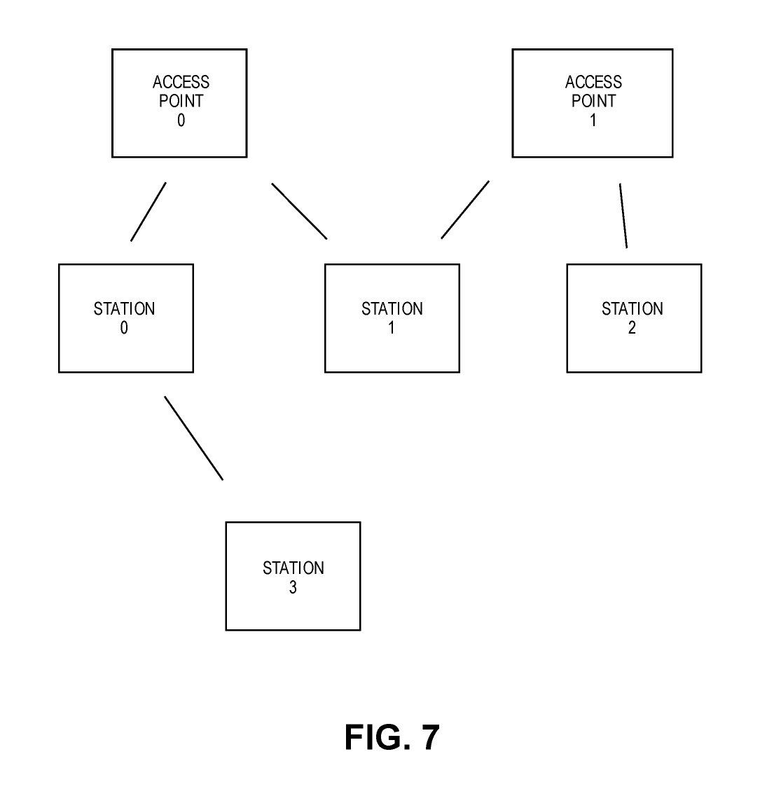

FIG. 6 is a block diagram of a network device implementing a STA or AP that executes a UL OFDMA acknowledgement component, according to some embodiments. In a wireless local area network (WLAN) such as the example WLAN illustrated in FIG. 7, a basic service set (BSS) includes a plurality of network devices referred to herein as WLAN devices. Each of the WLAN devices may include a medium access control (MAC) layer and a physical (PHY) layer according to IEEE 802.11 standard. In the plurality of WLAN devices, at least one WLAN device may be an AP station (e.g., access point 0 and access point 1 in FIG. 7) and the other WLAN devices may be non-AP stations (non-AP STAs), (e.g., stations 0-3 in FIG. 7). Alternatively, all of the plurality of WLAN devices may be non-AP STAs in an Ad-hoc networking environment. As shown in FIG. 7, a WLAN can have any combination of STAs and APs that can form a discrete network, an ad hoc network or any combination thereof. Any number of APs and STAs can be included in a WLAN and any topology and configuration of such APs and STAs in the network can be utilized.

As shown in FIG. 6, the example WLAN device 1 includes a baseband processor 10, a radio frequency (RF) transceiver 20, an antenna unit 30, memory 40, an input interface unit 50, an output interface unit 60, and a bus 70. The baseband processor 10 performs baseband signal processing, and includes a MAC processor 11 and a PHY processor 15. These processors can be any type of integrated circuit (IC) including a general processing unit or an application specific integrated circuit (ASIC). In some embodiments, the MAC processor 11 also implements a UL OFDMA acknowledgement component 600 (or more generally, a UL MU response transmission component). The UL OFDMA acknowledgement component 600 can implement the respective functions for any combination of the embodiments described herein above with regard to FIGS. 1-5. In other embodiments, the UL OFDMA acknowledgement component 600 may be implemented by or distributed over both the PHY processor 15 and the MAC processor 11. The UL OFDMA acknowledgement component 600 may be implemented as software or as hardware components of either the PHY processor 15 or MAC processor 11.

In one embodiment, the MAC processor 11 may include a MAC software processing unit 12 and a MAC hardware processing unit 13. The memory 40 may store software (hereinafter referred to as “MAC software”), including at least some functions of the MAC layer. The MAC software processing unit 12 executes the MAC software to implement some functions of the MAC layer and the MAC hardware processing unit 13 may implement the remaining functions of the MAC layer in hardware (hereinafter referred to “MAC hardware”). However, the MAC processor 11 is not limited to this distribution of functionality.

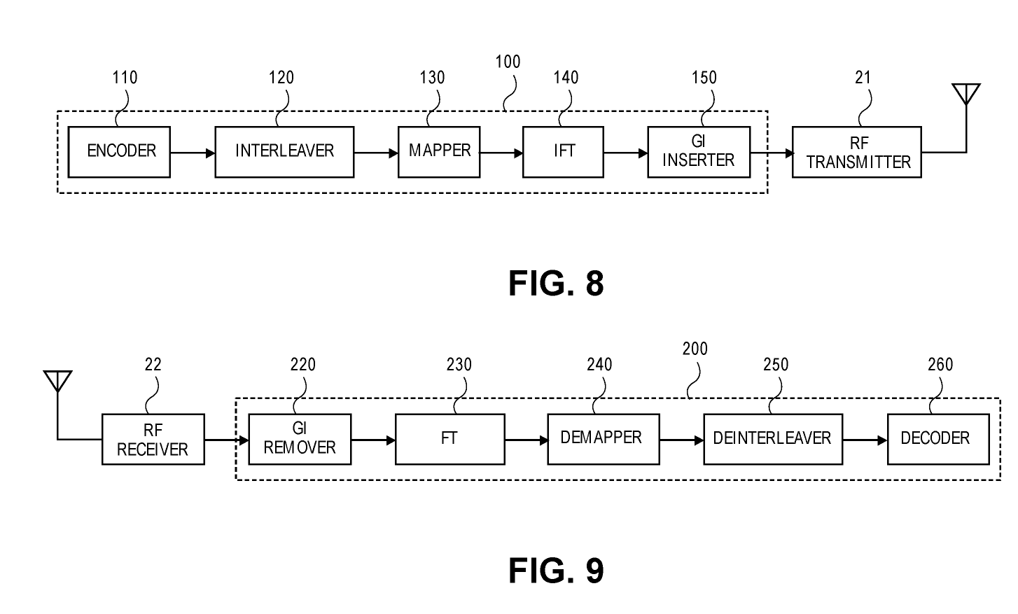

The PHY processor 15 includes a transmitting signal processing unit 100 and a receiving signal processing unit 200 described further herein below with reference to FIGS. 8 and 9.

The baseband processor 10, the memory 40, the input interface unit 50, and the output interface unit 60 may communicate with each other via the bus 70. The radio frequency (RF) transceiver 20 includes an RF transmitter 21 and an RF receiver 22. The memory 40 may further store an operating system and applications. In some embodiments, the memory may store recorded information about captured frames. The input interface unit 50 receives information from a user and the output interface unit 60 outputs information to the user.

The antenna unit 30 includes one or more antennas. When a MIMO or MU-MIMO system is used, the antenna unit 30 may include a plurality of antennas.

FIG. 8 is a schematic block diagram exemplifying a transmitting signal processor in a WLAN device, according to some embodiments. Referring to the above drawing, a transmitting signal processing unit 100 includes an encoder 110, an interleaver 120, a mapper 130, an inverse Fourier transformer (IFT) 140, and a guard interval (GI) inserter 150. The encoder 110 encodes input data. For example, the encoder 110 may be a forward error correction (FEC) encoder. The FEC encoder may include a binary convolutional code (BCC) encoder followed by a puncturing device or may include a low-density parity-check (LDPC) encoder.

The transmitting signal processing unit 100 may further include a scrambler for scrambling the input data before encoding to reduce the probability of long sequences of 0s or 1s. If BCC encoding is used in the encoder 110, the transmitting signal processing unit 100 may further include an encoder parser for demultiplexing the scrambled bits among a plurality of BCC encoders. If LDPC encoding is used in the encoder 110, the transmitting signal processing unit 100 may not use the encoder parser.

The interleaver 120 interleaves the bits of each stream output from the encoder to change the order of bits. Interleaving may be applied only when BCC encoding is used. The mapper 130 maps the sequence of bits output from the interleaver to constellation points. If LDPC encoding is used in the encoder 110, the mapper 130 may further perform LDPC tone mapping in addition to constellation mapping.

When multiple input-multiple output (MIMO) or multiple user (MU)-MIMO is used, the transmitting signal processing unit 100 may use a plurality of interleavers 120 and a plurality of mappers 130 corresponding to the number N_{SS} of spatial streams. In this case, the transmitting signal processing unit 100 may further include a stream parser for dividing outputs of the BCC encoders or the LDPC encoder into blocks that are sent to different interleavers 120 or mappers 130. The transmitting signal processing unit 100 may further include a space-time block code (STBC) encoder for spreading the constellation points from the N_{SS} spatial streams into N_{STS} space-time streams and a spatial mapper for mapping the space-time streams to transmit chains. The spatial mapper may use direct mapping, spatial expansion, or beamforming.

The IFT 140 converts a block of the constellation points output from the mapper 130 or the spatial mapper to a time domain block (i.e., a symbol) by using an inverse discrete Fourier transform (IDFT) or an inverse fast Fourier transform (IFFT). If the STBC encoder and the spatial mapper are used, the inverse Fourier transformer 140 may be provided for each transmit chain.

When MIMO or MU-MIMO is used, the transmitting signal processing unit 100 may insert cyclic shift diversities (CSDs) to prevent unintentional beamforming. The CSD insertion may occur before or after the inverse Fourier transform 140. The CSD may be specified per transmit chain or may be specified per space-time stream. Alternatively, the CSD may be applied as a part of the spatial mapper. When MU-MIMO is used, some blocks before the spatial mapper may be provided for each user.

The GI inserter 150 prepends a GI to the symbol. The transmitting signal processing unit 100 may optionally perform windowing to smooth edges of each symbol after inserting the GI. The RF transmitter 21 converts the symbols into an RF signal and transmits the RF signal via the antenna unit 30. When MIMO or MU-MIMO is used, the GI inserter 150 and the RF transmitter 21 may be provided for each transmit chain.

FIG. 9 is a schematic block diagram exemplifying a receiving signal processing unit in the WLAN device, according to some embodiments. Referring to FIG. 9, a receiving signal processing unit 200 includes a GI remover 220, a Fourier transformer (FT) 230, a demapper 240, a deinterleaver 250, and a decoder 260.

An RF receiver 22 receives an RF signal via the antenna unit 30 and converts the RF signal into symbols. The GI remover 220 removes the GI from the symbol. When MIMO or MU-MIMO is used, the RF receiver 22 and the GI remover 220 may be provided for each receive chain.

The FT 230 converts the symbol (i.e., the time domain block) into a block of constellation points by using a discrete Fourier transform (DFT) or a fast Fourier transform (FFT). The Fourier transformer 230 may be provided for each receive chain.

When MIMO or MU-MIMO is used, the receiving signal processing unit 200 may use a spatial demapper for converting the Fourier transformed receiver chains to constellation points of the space-time streams and an STBC decoder for despreading the constellation points from the space-time streams into the spatial streams.

The demapper 240 demaps the constellation points output from the Fourier transformer 230 or the STBC decoder to bit streams. If LDPC encoding is used, the demapper 240 may further perform LDPC tone demapping before constellation demapping. The deinterleaver 250 deinterleaves the bits of each stream output from the demapper 240. Deinterleaving may be applied only when BCC encoding is used.

When MIMO or MU-MIMO is used, the receiving signal processing unit 200 may use a plurality of demappers 240 and a plurality of deinterleavers 250 corresponding to the number of spatial streams. In this case, the receiving signal processing unit 200 may further include a stream deparser for combining the streams output from the deinterleavers 250.

The decoder 260 decodes the streams output from the deinterleaver 250 or the stream deparser. For example, the decoder 260 may be an FEC decoder. The FEC decoder may include a BCC decoder or an LDPC decoder. The receiving signal processing unit 200 may further include a descrambler for descrambling the decoded data. If BCC decoding is used in the decoder 260, the receiving signal processing unit 200 may further include an encoder deparser for multiplexing the data decoded by a plurality of BCC decoders. If LDPC decoding is used in the decoder 260, the receiving signal processing unit 200 may not use the encoder deparser.

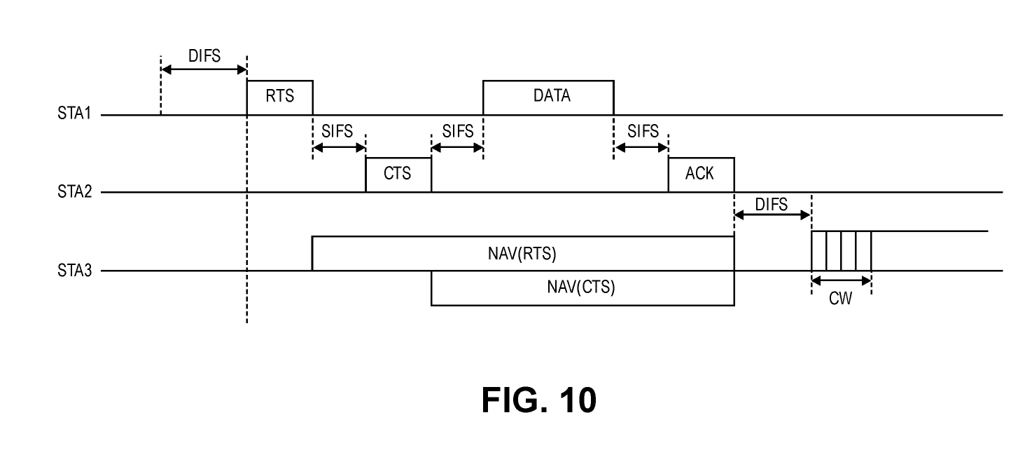

FIG. 10 is a timing diagram providing an example of the Carrier Sense Multiple Access/Collision Avoidance (CSMA/CA) transmission procedure, according to some embodiments. In the illustrated example, STA1 is a transmit WLAN device for transmitting data, STA2 is a receive WLAN device for receiving the data, and STA3 is a WLAN device, which may be located at an area where a frame transmitted from the STA1 and/or a frame transmitted from the STA2 can be received by the WLAN device.

STA1 may determine whether the channel is busy by carrier sensing. The STA1 may determine the channel occupation based on a quality of the signal on the channel or correlation of signals in the channel, or may determine the channel occupation by using a NAV timer.

When determining that the channel is not used by other devices during DIFS (that is, the channel is idle), STA1 may transmit an RTS frame to STA2 after performing backoff. Upon receiving the RTS frame, STA2 may transmit a CTS frame as a response of the CTS frame after SIFS. When STA3 receives the RTS frame, it may set the NAV timer for a transmission duration of subsequently transmitted frames (for example, a duration of SIFS+CTS frame duration+SIFS+data frame duration+SIFS+ACK frame duration) by using duration information included in the RTS frame. When STA3 receives the CTS frame, it may set the NAV timer for a transmission duration of subsequently transmitted frames (for example, a duration of SIFS+data frame duration+SIFS+ACK frame duration) by using duration information included in the CTS frame. Upon receiving a new frame before the NAV timer expires, STA3 may update the NAV timer by using duration information included in the new frame. STA3 does not attempt to access the channel until the NAV timer expires.

When STA1 receives the CTS frame from the STA2, it may transmit a data frame to the STA2 after SIFS elapses from a time when the CTS frame has been completely received. Upon successfully receiving the data frame, the STA2 may transmit an ACK frame as a response of the data frame after SIFS elapses.

When the NAV timer expires, STA3 may determine whether the channel is busy through the use of carrier sensing techniques. Upon determining that the channel is not used by other devices during DIFS and after the NAV timer has expired, STA3 may attempt channel access after a contention window according to random backoff elapses.

A PHY-RXSTART.indication primitive is an indication by the physical layer (PHY) to the local MAC entity that the PHY has received a valid start of a PPDU, including a valid PHY header. This primitive is generated by the local PHY entity and provided to the MAC sublayer when the PHY has successfully validated a PHY header at the start of a new PPDU. This primitive provides the following parameters:

PHY-RXSTART.indication(

RXVECTOR

)

The RXVECTOR parameter represents a list of parameters that the local PHY entity provides to the local MAC entity upon receipt of a valid PHY header or upon receipt of the last PSDU data bit in a received frame.

After generating a PHY-RXSTART.indication primitive, the PHY is expected to maintain a physical medium busy status during the period that it takes for the PHY to transfer a frame of the indicated LENGTH at the indicated DATARATE. The physical medium busy status may be maintained even if a PHY-RXEND.indication(CarrierLost) primitive or a PHY-RXEND.indication(FormationViolation) primitive is generated by the PHY prior to the end of this period.

A PHY-RXEND.indication primitive is an indication by the PHY to the local MAC entity that the PSDU currently being received is complete. This primitive is generated by the local PHY entity and provided to the MAC sublayer to indicate that the receive state machine has completed a reception with or without errors. This primitive provides the following parameters:

PHY-RXEND.indication(

RXERROR,
RXVECTOR

)

The RXERROR parameter can convey one or more of the following values: NoError, FormatViolation, CarrierLost, Unsupported Rate and Filtered. A number of error conditions may occur after the PHY's receive state machine has detected what appears to be a valid preamble and Start Frame Delimiter (SFD). NoError is a value used to indicate that no error occurred during the receive process in the PHY. FormatViolation is a value used to indicate that the format of the received PPDU was in error. CarrierLost is a value used to indicate that the carrier was lost during the reception of the incoming PSDU and no further processing of the PSDU can be accomplished. UnsupportedRate is a value that is used to indicate that a non-supported data rate was detected during the reception of the incoming PPDU. Filtered is a value used to indicate that the incoming PPDU was filtered out during the reception of the incoming PPDU due to a condition set in the PHYCONFIG_VECTOR. In the case of an RXERROR value of NoError, the MAC may use the PHY-RXEND.indication primitive as a reference for channel access timing.

The RXVECTOR parameter represents a list of parameters that the local PHY entity provides to the local MAC entity upon receipt of a valid PHY header or upon receipt of the last PSDU data bit in a received frame. RXVECTOR may only be included when dot11RadioMeasurementActivated is true. This vector may contain both MAC and MAC management parameters.

The solutions provided herein have been described with reference to a wireless LAN system; however, it should be understood that these solutions are also applicable to other network environments, such as cellular telecommunication networks, wired networks, and similar communication networks.

An embodiment may be an article of manufacture in which a non-transitory machine-readable medium (such as microelectronic memory) has stored thereon instructions which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

Some portions of the preceding detailed descriptions have been presented in terms of algorithms and symbolic representations of operations on data bits within a computer memory. These algorithmic descriptions and representations are the ways used by those skilled in conferencing technology to most effectively convey the substance of their work to others skilled in the art. An algorithm is here, and generally, conceived to be a self-consistent sequence of operations leading to a desired result. The operations are those requiring physical manipulations of physical quantities. It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a conference device, or similar electronic computing device, that manipulates and transforms data represented as physical (electronic) quantities within the conference device's registers and memories into other data similarly represented as physical quantities within the conference device's memories or registers or other such information storage, transmission or display devices.

While the flow diagrams in the figures herein show a particular order of operations performed by certain embodiments, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method implemented by a station (STA) in a Wireless Local Area Network (WLAN) to provide an uplink (UL) Orthogonal Frequency Division Multiple Access (OFDMA) acknowledgement, the method comprising:
receiving a first Physical Layer Protocol Data Unit (PPDU), wherein the first PPDU includes a Media Access Control (MAC) Protocol Data Unit (MPDU), wherein a MAC header of the MPDU includes a High Efficiency (HE) variant High Throughput (HT) Control field, wherein the HE variant HT Control field includes a Simplified Scheduling Information subfield that carries scheduling information for scheduling the UL OFDMA acknowledgement;
generating a second PPDU in response to receiving the first PPDU, wherein the second PPDU includes an acknowledgement frame;
determining a cyclic prefix length of the first PPDU;
determining an uplink cyclic prefix length to apply to the second PPDU based on the cyclic prefix length of the first PPDU, wherein the uplink cyclic prefix length is longer than the cyclic prefix length of the first PPDU when the cyclic prefix length of the first PPDU is shorter than a maximum allowed cyclic prefix length; and
transmitting the second PPDU through a wireless medium according to the scheduling information, where the uplink cyclic prefix length is applied to the second PPDU.

2. The method of claim 1, wherein the uplink cyclic prefix length is 3.2 microseconds when the cyclic prefix length of the first PPDU is 1.6 microseconds.

3. The method of claim 1, wherein the uplink cyclic prefix length is 1.6 microseconds when the cyclic prefix length of the first PPDU is 0.8 microseconds.

4. The method of claim 1, wherein the uplink cyclic prefix length is same as the maximum allowed cyclic prefix length when the cyclic prefix length of the first PPDU is same as the maximum allowed cyclic prefix length.

5. The method of claim 4, wherein the maximum allowed cyclic prefix length is 3.2 microseconds.

6. The method of claim 1, wherein the cyclic prefix length of the first PPDU is determined from an RXVECTOR of the first PPDU.

7. The method of claim 1, wherein the Simplified Scheduling Information subfield includes a PPDU length subfield to carry information regarding a length of the second PPDU.

8. The method of claim 1, wherein the Simplified Scheduling Information subfield includes a Resource Unit (RU) Indication subfield to carry information regarding a transmission resource that the STA is to use.

9. The method of claim 1, wherein the Simplified Scheduling Information includes a Modulation Coding Scheme (MCS) subfield to carry information regarding the MCS that the STA is to use.

10. The method of claim 1, wherein the acknowledgement frame is a standard Acknowledgement (ACK) frame or a Block Acknowledgement (BA) frame.

11. A network device to function as a station (STA) in a Wireless Local Area Network (WLAN) to participate in an uplink (UL) multi-user (MU) response transmission, the network device comprising:
a Radio Frequency (RF) transceiver;
a set of one or more processors; and
a non-transitory machine-readable medium having stored therein a UL MU response transmission component, which when executed by the set of one or more processors, causes the network device to receive a first Physical Layer Protocol Data Unit (PPDU), wherein the first PPDU includes a Media Access Control (MAC) Protocol Data Unit (MPDU), wherein a MAC header of the MPDU includes a High Efficiency (HE) variant High Throughput (HT) Control field, wherein the HE variant HT Control field includes a Simplified Scheduling Information subfield that carries scheduling information for scheduling the UL MU response transmission, generate a second PPDU in response to receiving the first PPDU, determine a cyclic prefix length of the first PPDU, determine an uplink cyclic prefix length to apply to the second PPDU based on the cyclic prefix length of the first PPDU, wherein the uplink cyclic prefix length is longer than the cyclic prefix length of the first PPDU when the cyclic prefix length of the first PPDU is shorter than a maximum allowed cyclic prefix length, and transmit the second PPDU through a wireless medium according to the scheduling information, where the uplink cyclic prefix length is applied to the second PPDU.

12. The network device of claim 11, wherein the uplink cyclic prefix length is 3.2 microseconds when the cyclic prefix length of the first PPDU is 1.6 microseconds.

13. The network device of claim 11, wherein the uplink cyclic prefix length is 1.6 microseconds when the cyclic prefix length of the first PPDU is 0.8 microseconds.

14. The network device of claim 11, wherein the uplink cyclic prefix length is same as the maximum allowed cyclic prefix length when the cyclic prefix length of the first PPDU is same as the maximum allowed cyclic prefix length.

15. The network device of claim 14, wherein the maximum allowed cyclic prefix length is 3.2 microseconds.

16. The network device of claim 11, wherein the cyclic prefix length of the first PPDU is determined from an RXVECTOR of the first PPDU.

17. The network device of claim 11, wherein the Simplified Scheduling Information subfield includes a PPDU length subfield to carry information regarding a length of the second PPDU.

18. The network device of claim 11, wherein the Simplified Scheduling Information subfield includes a Resource Unit (RU) Indication subfield to carry information regarding a transmission resource that the STA is to use.

19. The network device of claim 11, wherein the Simplified Scheduling Information includes a Modulation Coding Scheme (MCS) subfield to carry information regarding the MCS that the STA is to use.

20. The network device of claim 11, wherein the second PPDU includes an acknowledgement frame.
